(19) United States
(12) Patent Application Publication
(10) Pub. No.: US 2009/0110972 A1
(43) Pub. Date: Apr. 30, 2009

(54) FUEL CELL SYSTEM

(75) Inventors: Tadashi SHOJI, Yokosuka-shi (JP); Karuki HAMADA, Yokohama-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 12/342,731

(22) Filed: Dec. 23, 2008

Related U.S. Application Data
(62) Division of application No. 10/926,387, filed on Aug. 26, 2004.

(30) Foreign Application Priority Data
Aug. 27, 2003 (JP) 2003-209004

(51) Int. Cl. H01M 8/04

(52) U.S. Cl. 429/17

(57) ABSTRACT

A fuel cell system is provided with: a fuel cell generating electrical power by causing hydrogen and oxygen to react; a burner burning discharge cathode gas and discharge anode gas from the fuel cell; a cathode line supplying cathode gas to the fuel cell; an anode line which supplying anode gas to the fuel cell; a cathode switch valve switching the flow of cathode gas in the cathode line; a cathode bypass line connecting the cathode switch valve and the burner; and a controller controlling the cathode switch valve to supply cathode gas via the cathode bypass line to the catalyst burner, without supplying anode gas to the burner, to cause temperature of exhaust gas of the burner to rise so as to reduce an amount of water vapor in the burner to a predetermined level, thereafter stopping the fuel cell system.

The present application is a divisional of U.S. application Ser. No. 10/926,387, filed Aug. 26, 2004, the entire contents of which is incorporated herein by reference.

### BACKGROUND OF THE INVENTION

The fuel cell system currently described by JP2002-343391A is equipped with a catalytic burner which burns hydrogen discharged from a Polymer Electrolyte Fuel Cell [PEFC] in order to prevent discharge of hydrogen to the atmosphere. While the PEFC using a solid high polymer electrolyte has a low temperature of operation and handling is easy, the high polymer electrolyte film has the characteristic of not fully demonstrating hydrogen ion conductivity, if not fully humidified. The solid high polymer type fuel cell has a stratified structure that alternately piles up a separator and a resin film with hydrogen conductivity. The separator forms the hydrogen channel in one side, and forms the air channel in an opposite side. The fuel cell system is comprised of a hydrogen supply device with which a fuel cell system supplies hydrogen as fuel gas, a compressor that supplies air as oxidizer gas, and a fuel cell stack which has an anode and a cathode. However, part of the hydrogen supplied to a fuel cell is emitted, without reacting. This happens when the hydrogen concentration in a fuel cell is less than minimum concentration. This unreacted hydrogen is emitted as discharge hydrogen, and its concentration may exceed a lower flammability limit near an outlet. Therefore, it is necessary to prevent the emitted hydrogen concentration from reaching flammable range.

For this reason, the fuel cell system equips the discharge hydrogen line with a catalytic burner for burning discharge hydrogen. This catalytic burner has prevented discharge of hydrogen to the atmosphere by burning unreacted discharge hydrogen. However, since a fuel cell maintains a humidification state as above-mentioned in order to make hydrogen and oxygen react, water vapor also flows into a catalytic burner with discharge gas. If moisture exists in a catalytic burner, the catalytic burner cannot demonstrate sufficient inflammable ability. Accordingly, a blower is established in a catalytic burner, air is inhaled from the exterior, and combustion of discharge hydrogen is promoted.

### SUMMARY OF THE INVENTION

However, in the fuel cell system mentioned above, in the case of rainy weather, or in high humidity, since water vapor is contained in the air which is inhaled by the blower, a catalytic burner does not function properly. Furthermore, when a catalytic burner is filled with high humidity air, when a fuel cell stops and temperature falls, the water vapor in a catalytic burner may saturate, and moisture may condense on the catalyst surface. When moisture adheres to the catalyst surface, it becomes impossible for the catalytic burner to burn hydrogen. Therefore, it is desirable to reduce the amount of water vapor in a burner as much as possible at the time of a stop of the fuel cell system. Moreover, because a car has space restrictions, the system which needs both the compressors which supply air to a fuel cell and the blower for burners is not desirable.

In order to achieve the above object, the present invention provides a fuel cell system comprising a fuel cell which generates electrical power by causing hydrogen and oxygen to react; a burner which burns the discharge cathode gas and discharge anode gas from the fuel cell; a cathode line which supplies cathode gas to the fuel cell; an anode line which supplies anode gas to the fuel cell; a cathode switch valve which switches the flow of cathode gas in the middle of the cathode line; a cathode bypass line which connects the cathode switch valve and the catalytic burner; and a controller which controls the cathode switch valve to supply cathode gas to the catalytic burner when a fuel cell stops.

Since the water vapor in the catalytic burner can be transposed to cathode gas and the water vapor in the catalytic burner can be decreased, a catalyst carries out activity quickly at the time of starting of the fuel cell. Moreover, since it becomes unnecessary to provide the blower that takes in air from the exterior to the catalytic burner, the fuel cell system becomes simple in composition.

The details as well as other features and advantages of this invention are set forth in the remainder of the specification and are shown in the accompanying drawings.

### BRIEF DESCRIPTION OF THE DRAWINGS

FIG. 1 is a schematic diagram of a fuel cell system according to a first embodiment of this invention.

FIG. 2 is a flow chart explaining stop control processing according to the first embodiment of this invention.

FIG. 3 is a schematic diagram of a fuel cell system according to a second embodiment of this invention.

FIG. 4 is a flow chart explaining stop control processing according to the second embodiment of this invention.

FIG. 5 is a schematic diagram of a fuel cell system according to a third embodiment of this invention.

FIG. 6 is a flow chart explaining stop control processing according to the third embodiment of this invention.

### DESCRIPTION OF THE PREFERRED EMBODIMENTS

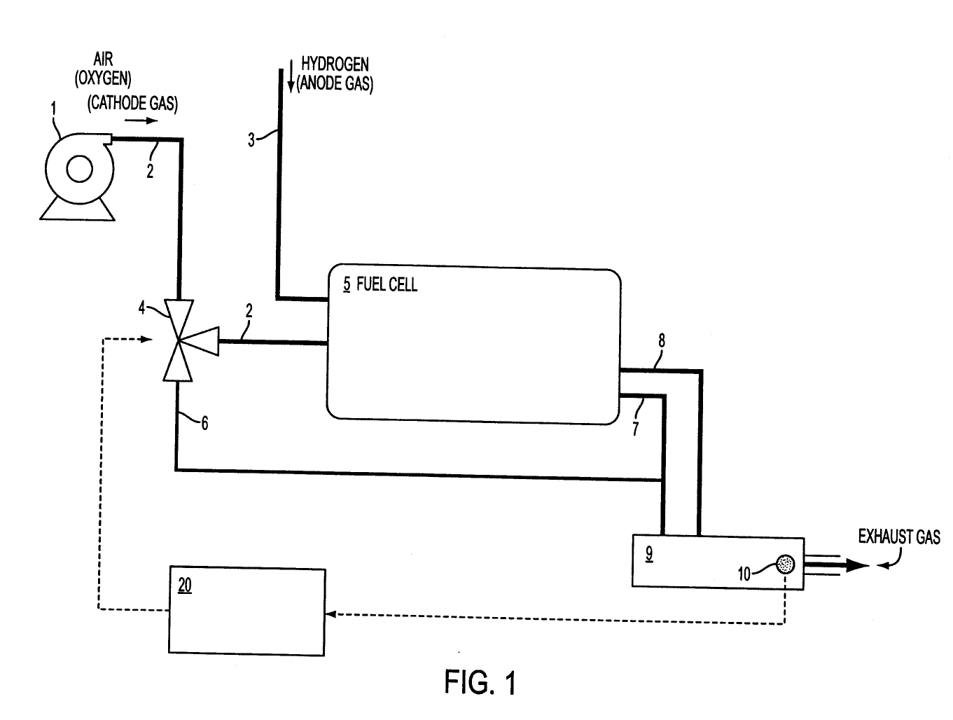

FIG. 1 shows the composition of the first embodiment of the operation of the fuel cell system of this invention.

As shown in FIG. 1, a fuel cell system is comprised of a compressor 1 which supplies air (cathode gas) including oxygen gas, and a cathode line 2 which supplies air compressed by the compressor 1 to a fuel cell 5, and an anode line 3 which supplies hydrogen (anode gas) to the fuel cell 5, and a catalytic burner 9 which uses a precious-metal catalyst and burns discharge hydrogen from the fuel cell 5, and a cathode exhaust gas line 7 which discharges the oxygen after a reaction from the fuel cell 5 to the catalytic burner 9, and an anode exhaust gas line 8 which discharges the hydrogen after a reaction from the fuel cell 5 to the catalytic burner 9, and an exhaust temperature sensor 10 which measures the temperature of the exhaust gas discharged from the catalytic burner 9.

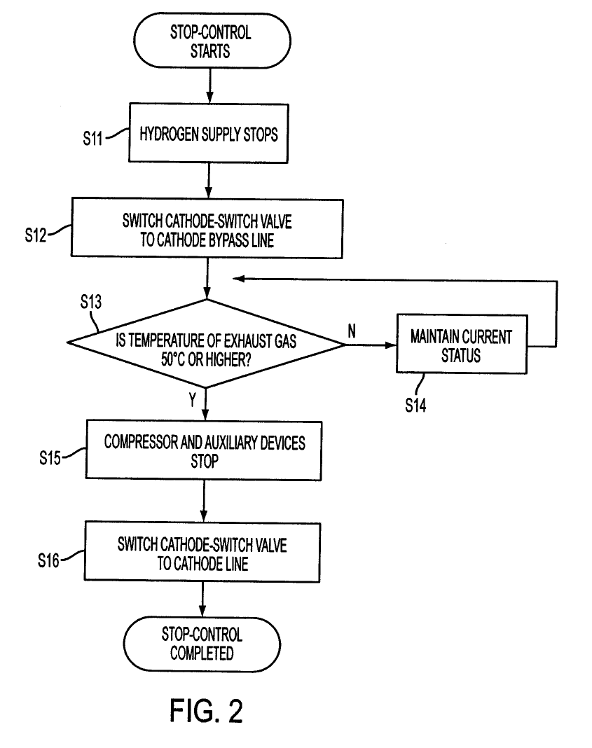

A cathode switch valve 4 is provided in the middle of the cathode line 2. The cathode switch valve 4 switches the flow of oxygen to the cathode line 2 or to a cathode bypass line 6. The cathode bypass line 6 is connected to the cathode exhaust gas line 7. A controller 20 performs control of the cathode switch valve 4. Below, the concrete control logic of a controller 20 is explained along with the flow chart shown in a FIG. 2.

Stop control of the fuel cell system is performed as follows. First, in step S11, supply of the hydrogen to the fuel cell 5 is stopped. In step S12, the cathode switch valve 4 is switched to the cathode bypass line 6. The air which does not go through the fuel cell 5, i.e., the non-saturated air is supplied to the catalytic burner 9. In step S113, it is judged whether the temperature of an exhaust gas rises above a predetermined temperature (in this embodiment 50 degrees C.). This state is maintained until the temperature of an exhaust gas rises to predetermined temperature (step S14). If the temperature of an exhaust gas rises to predetermined temperature, processing will progress to step S15. The reason for judging whether the temperature of an exhaust gas rises above a predetermined temperature is the following. Ceramic particles are contained in the catalytic burner 9, and since a ceramic particle is porous, it has a water retention nature. The moisture contained in the porous object evaporates by passing air from the cathode bypass line 6. When the porous object is retaining water, the gas temperature around the object falls by evaporation cooling, and the temperature of the exhaust gas falls. Furthermore, if circulation of air is continued, the moisture in a burner evaporates and the temperature begins to rise soon. Therefore, it is possible to judge that the amount of water retention of a porous object has decreased by detecting the rise of the temperature of the exhaust gas. The temperature when the moisture in a burner fully evaporates is set as the predetermined temperature, and the processing judges whether the moisture in a burner evaporates by whether the temperature goes up to the predetermined temperature. Operation of a compressor and other auxiliaries are stopped in step S15, and in step S16, the cathode switch valve 4 is returned to the cathode line 2, and the processing ends.

According to this embodiment, the cathode switch valve 4 is provided in the middle of the cathode line 2, and when the fuel cell system stops, the air (non-saturated) of compressor 1 bypasses the fuel cell 5, and are supplied to the catalytic burner 9. Although the cathode exhaust gas of saturated water vapor is circulating to the catalytic burner 9 at the time of regular operation of a fuel cell, the non-saturated air which bypasses the fuel cell 5 and is supplied to the catalytic burner 9 can replace the inside of the catalytic burner 9 with dry air at the time of stop control. Therefore, the amount of water vapor in the catalytic burner 9 is decreased at the time of a stop, and a catalyst is quickly activated at the time of re-starting.

Moreover, since it is not necessary to install the air source for exclusive use by the catalytic burner, the fuel cell system has a simple composition, and it saves weight and space in vehicles. Furthermore, if the temperature of an exhaust gas (measured by the exhaust temperature sensor 10) rises more than the predetermined temperature, the fuel cell system is suspended. The fuel cell system can judge correctly whether the moisture in the catalytic burner is fully evaporated. Therefore, the operation time of a compressor 1 is appropriately controllable.

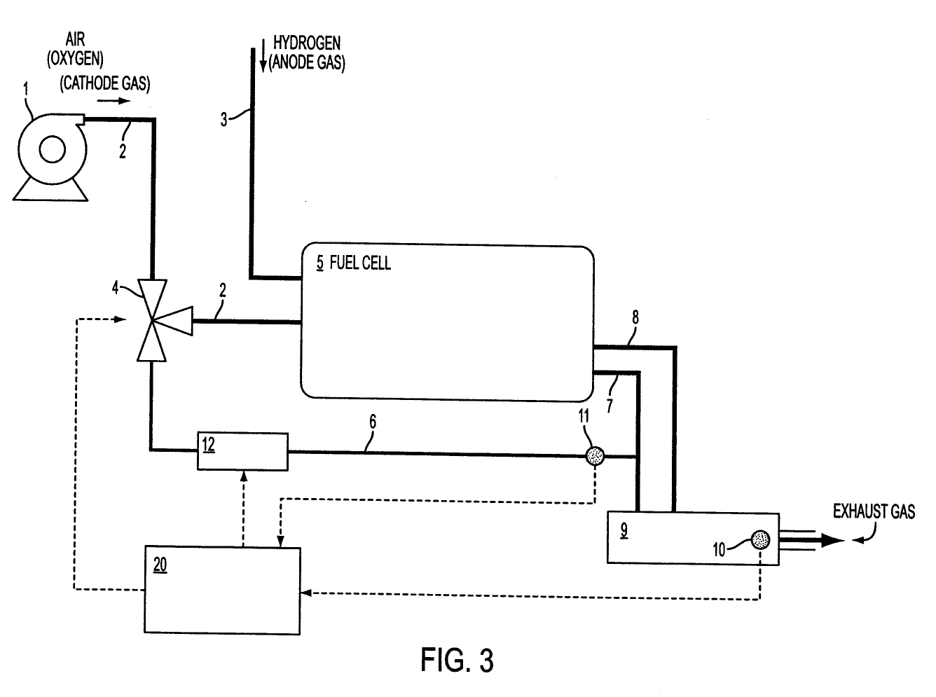

FIG. 3 shows the composition of the second embodiment of the operation of the fuel cell system of this invention. In this embodiment, a heating device 12 is provided in the middle of the cathode bypass line 6 of the first embodiment. The heating device 12 uses electric heaters, such as electrical resistance heating, and energy efficiency of such heating device 12 is good and it can also attain miniaturization of space. A cathode gas temperature sensor 11 is provided near the down stream end of the cathode bypass line 6, and the cathode gas temperature sensor 11 measures the temperature of the air (cathode gas), which flows in the cathode bypass line 6. Other composition and actions are the same as that of the first embodiment.

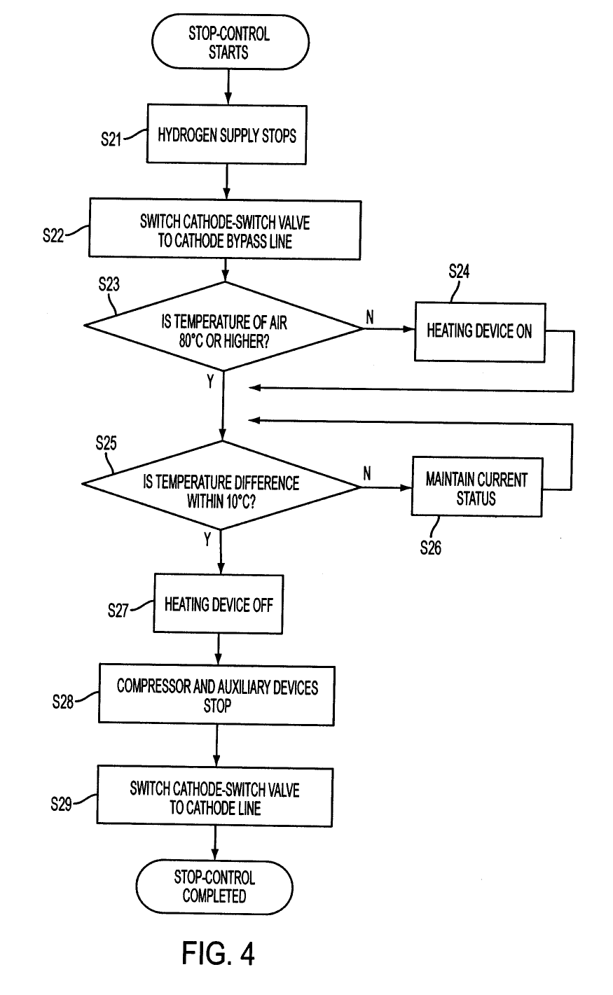

Below, the concrete control logic of a controller 20 is explained along with the flow chart shown in FIG. 4.

Stop control of the fuel cell system is performed as follows. First, in step S21, supply of the hydrogen to the fuel cell 5 is stopped. In step S22, the cathode switch valve 4 is switched to the cathode bypass line 6. The air does not go through the fuel cell 5 but instead, the non-saturated air is supplied to the catalytic burner 9. In step S23, the cathode gas temperature sensor 11 measures the temperature of the air which flows in the cathode bypass line 6. If the temperature of the air which flows in the cathode bypass line 6 does not fulfill a predetermined temperature (in this embodiment 80 degrees C.), the air is heated by the operation of the heating device 12 (step S24). This predetermined temperature is sufficient to evaporate the moisture in the catalytic burner 9. In step S25, it is judged whether the difference of temperature between the temperature (measured value of the cathode gas temperature sensor 11) of air and the temperature (measured value of the exhaust temperature sensor 10) of the exhaust gas is less than a predetermined difference of temperature (in this embodiment 10 degrees C.). When the difference of temperature is not less than a predetermined difference of temperature, operation of the heating device 12 is continued (step S26). If the difference of temperature becomes within the predetermined difference of temperature, processing will progress to step S27.

The reason for judging whether the difference of temperature is less than the predetermined difference of temperature is the following.

If air is passed from the cathode bypass line 6 when the catalytic burner 9 is humid, the temperature of the exhaust gas will fall by evaporation cooling. Furthermore, if circulation of air is continued as it is, the moisture in the catalytic burner 9 evaporates, the temperature begins to rise soon, and the difference of temperature of the temperature (measured value of the cathode gas temperature sensor 11) of air and the temperature (measured value of the exhaust temperature sensor 10) of an exhaust gas decreases. The difference of temperature when the moisture in the catalytic burner 9 fully evaporates is set beforehand, and the difference of temperature at that time is set as the predetermined difference of temperature.

In step S27, the heating device 12 stops operation. Operation of a compressor and other auxiliaries are stopped in step S28, and in step S29, the cathode switch valve 4 is returned to the cathode line 2, and the processing ends.

According to this embodiment, since the fuel cell system has the heating device 12 which heats the air which flows in the cathode bypass line 6, the fuel cell system promotes evaporation of the moisture in the catalytic burner 9, and shortens the time required to stop the fuel cell system.

Moreover, the fuel cell system can detect the evaporation cooling of a porous object correctly, even if the temperature of the air which flows in the cathode bypass line 6 charges, since the fuel cell system stops if the difference of temperature of the air which flows in the cathode bypass line 6, and the exhaust gas becomes within a predetermined difference of temperature.

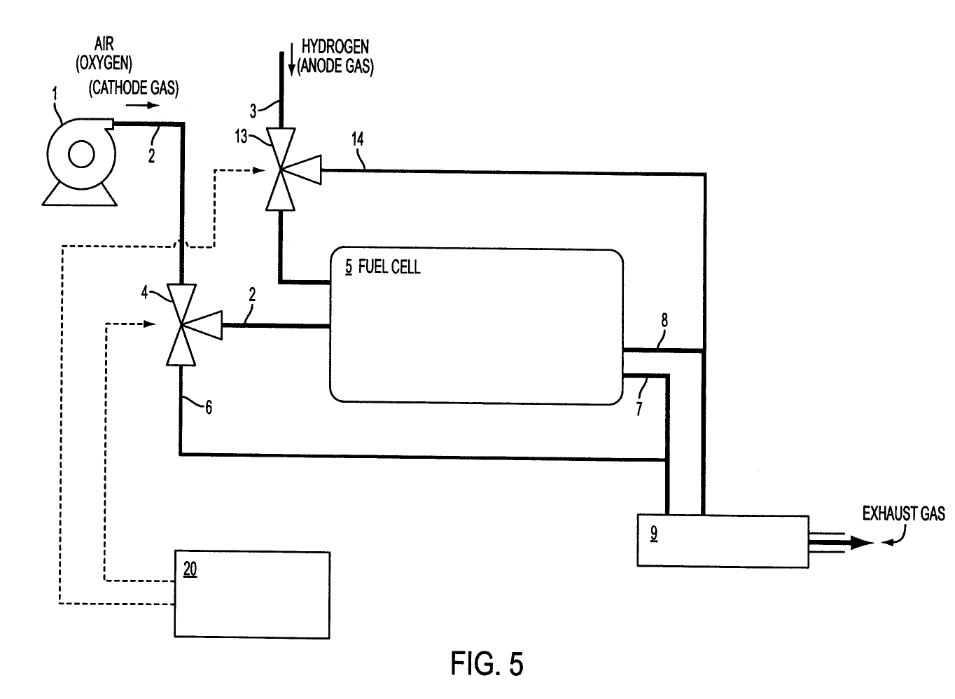

FIG. 5 shows the composition of the third embodiment of the operation of the fuel cell system of this invention. In this embodiment, the fuel cell system has an anode switch valve 13. The anode switch valve 13 switches the flow of hydrogen to the anode line 3 or an anode bypass line 14. The anode bypass line 14 is connected to the anode exhaust gas line 8.

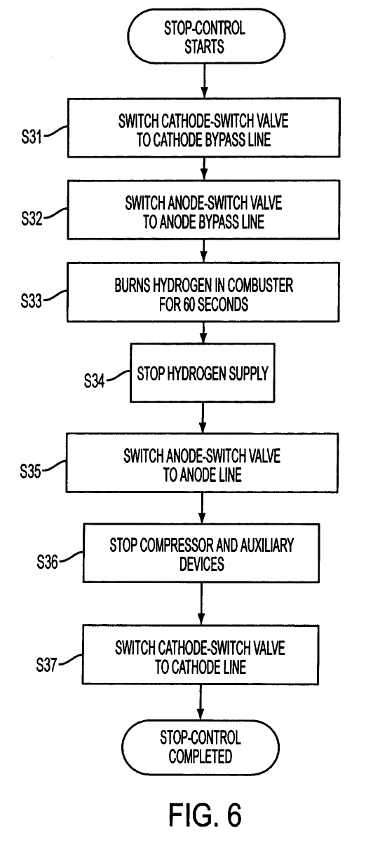

Below, the concrete control logic of a controller 20 is explained along with the flow chart shown in FIG. 6.

Stop control of the fuel cell system is performed as follows. First, in step S31, the cathode switch valve 4 is switched to the cathode bypass line 6. The air does not go through the fuel cell 5 but instead, the non-saturated air is supplied to the catalytic burner 9.

In step S32, the anode switch valve 13 is switched to the anode bypass line 14. The hydrogen that does not go through the fuel cell 5, i.e., the unreacted hydrogen, is supplied to the catalytic burner 9. In step S33, the catalytic burner 9 operates so that the hydrogen and air that are supplied react and burn. The controller 20 calculates the flow of hydrogen and air to obtain the predetermined temperature and hydrogen is burned for the predetermined combustion time which can remove the moisture in the catalytic burner at the temperature. In this embodiment, combustion time is set at 60 seconds. After maintaining operation of step S33 for 60 seconds, step S34 is performed.

In step S34, the hydrogen supply to the anode switch valve 13 is stopped. In step S35, and the anode switch valve 13 is returned to the anode line 3. Operation of a compressor and other auxiliaries are stopped in step S36, and in step S37, the cathode switch valve 4 is returned to the cathode line 2, and the processing ends.

According to this embodiment, the fuel cell system has the anode switch valve 13 in the middle of the anode line 3. When the fuel cell system stops, hydrogen flows to the catalytic burner 9 through the anode bypass line 14 by the operation of the anode switch valve 13. Before the fuel cell system stops, the temperature of the catalytic burner 9 rises by combustion of hydrogen. The fuel cell system promotes evaporation of the moisture in the catalytic burner 9, and shortens the time required to stop the fuel cell system.

Moreover, the fuel cell system stops the hydrogen of the anode bypass line 14 (step S34), before it stops air from the cathode bypass line 6, and then it suspends a compressor 1 (step S36), and changes the cathode switch valve 4 to the cathode line 2 (step S37). Therefore, the fuel cell system can purge the inside of the catalytic burner 9 with air after hydrogen combustion, and can further control re-condensation of reaction water.

Furthermore, since the fuel cell system operates so that the combustion time for removing the moisture in the catalytic burner 9 may be found beforehand and the catalytic burner 9 may burn hydrogen only for this time, the exhaust temperature sensor 10 in the first embodiment becomes unnecessary, and the fuel cell system holds down the cost of a system.

This invention is not limited to the explained embodiments, and various modifications and changes are possible.

For example, in the first and the second embodiments, end of control may not be performed based on temperature, but an end of control may be made like the third embodiment based on time. If it does so, since a temperature sensor will become unnecessary, cost can be held down. Moreover, in the third embodiment, the fuel cell system can also make an end of control judgment based on temperature like the first and the second embodiments and an exact judgment can be made.

Moreover, in the third embodiment, the fuel cell system can also include the heating device 12 in the middle of the cathode bypass line 6 like the second embodiment. If the heating device is provided, evaporation of the moisture in the catalytic burner 9 will be promoted further, and it will become possible to shorten the stop time of a fuel cell system further. The entire contents of Japanese Application No. 2003-209004, filed Aug. 27, 2003, on which this application is based, is incorporated herein by reference.

What is claimed is:

1. A control method controlling operation of a fuel cell comprising:
supplying cathode gas to the fuel cell;
supplying anode gas to the fuel cell;
generating electrical power by causing hydrogen and oxygen to react;
burning discharge cathode gas and discharge anode gas from the fuel cell by a burner;
switching a cathode switch valve in a cathode line, which supplies cathode gas to the fuel cell, to switch the cathode line flow of cathode gas to the burner to pass by the fuel cell when the fuel cell stops operation; and
switching the cathode switch valve back to the cathode line when the temperature of exhaust gas discharged from the burner has been raised to remove moisture from the burner.

2. The method according to claim 1, wherein the cathode gas supplied to the burner is heated when the fuel cell stops operation.

3. The method according to claim 2, wherein the cathode gas supplied to the burner is heated by an electrically heated heating device.

4. The method according to claim 1, wherein the burner is a catalyst burner which uses a precious-metal catalyst.

5. The method according to claim 1, wherein the fuel cell stops operation, if the temperature of the exhaust gas exceeds a predetermined temperature.

6. The method according to claim 1, wherein the fuel cell stops operation, if the difference of temperature of the exhaust gas and the cathode gas becomes within a predetermined difference of temperature.

7. The method according to claim 1, wherein the fuel cell stops operation based on lapsed time after changing the position of the cathode switch valve.
